(19) United States
(12) Patent Application Publication
(10) Pub. No.: US 2022/0201647 A1
(43) Pub. Date: Jun. 23, 2022

(54) METHOD AND APPARATUS FOR COMBINING MO EDT PROCEDURE WITH MT EDT PROCEDURE IN A WIRELESS COMMUNICATION SYSTEM

(71) Applicant: LG ELECTRONICS INC., Seoul (KR)

(72) Inventors: Hyunjung CHOE, Seoul (KR); Youngdae LEE, Seoul (KR); Seungjune YI, Seoul (KR)

(73) Assignee: LG ELECTRONICS INC., Seoul (KR)

(21) Appl. No.: 17/594,509

(22) PCT Filed: Apr. 29, 2020
(86) PCT No.: PCT/KR2020/005650

§ 371 Date: Oct. 20, 2021

Related U.S. Application Data
(60) Provisional application No. 62/842,507, filed on May 2, 2019.

(51) Int. Cl. H04W 68/00; H04W 74/00; H04W 72/14

(52) U.S. Cl. CPC H04W 68/005; H04W 72/14; H04W 74/006

(57) ABSTRACT

A method and apparatus for combining MO EDT procedure with MT EDT procedure in a wireless communication system is provided. A wireless device receives, from a network, a paging including an indication informing that a mobile terminated early data transmission (MT EDT) procedure is initiated. A wireless device receives initiates the MT EDT procedure. A wireless device receives transmits, to the network, a specific random access preamble in the MT EDT procedure, wherein the specific random access preamble informs that an UL data originated by the wireless device is available.

### TECHNICAL FIELD

The present disclosure relates to a method and apparatus for combining MO EDT procedure with MT EDT procedure in a wireless communication system.

### RELATED ART

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

In Rel-13, narrowband internet-of-things (NB-IoT) and LTE for machine-type communication (LTE-M) were standardized to provide wide-area connectivity for IoT. The technologies in Rel-14 evolved beyond the basic functionality specified in Rel-13. In Rel-15, to optimize the support for infrequent small data packet transmissions.

For internet-of-things (IOT) user equipment (UE) such as MTC UE and NB-IOT, there are high requirements on the life of battery. Power consumption of wireless device is a key improvement indicator. In the long term evolution (LTE) R-16, one technical requirement is to support uplink transmission in RRC idle mode so that the wireless device could save the power used to enter RRC connected mode.

### SUMMARY

A wireless device may receive downlink (DL) via RRC message during random access procedure. For example, a wireless device may receive the DL data by mobile terminated (MT) early data transmission (EDT) procedure.

In the MT EDT procedure, a wireless device could have mobile-originated (MO) data to be transmitted. However, there is no procedure for transmitting the MO data during the MT EDT procedure. For example, a wireless device may enter a connected state after the MT EDT procedure to transmit the MO UL data. For another example, a wireless device may initiate the MO EDT procedure after performing the MT EDT procedure.

Therefore, studies for combining the MO EDT procedure with MT EDT procedure in a wireless communication system are required.

In an aspect, a method performed by a wireless device in a wireless communication system is provided. A wireless device receives, from a network, a paging including an indication informing that a mobile terminated early data transmission (MT EDT) procedure is initiated. A wireless device receives initiates the MT EDT procedure. A wireless device receives transmits, to the network, a specific random access preamble in the MT EDT procedure, wherein the specific random access preamble informs that an UL data originated by the wireless device is available.

In another aspect, a wireless device in a wireless communication system is provided. A wireless device includes a transceiver, a memory, and at least one processor operatively coupled to the transceiver and the memory. The at least one processor is configured to control the transceiver to receive, from a network, a paging including an indication informing that a mobile terminated early data transmission (MT EDT) procedure is initiated. The at least one processor is configured to initiate the MT EDT procedure. The at least one processor is configured to control the transceiver to transmit, to the network, a specific random access preamble in the MT EDT procedure, wherein the specific random access preamble informs that an UL data originated by the wireless device is available.

The present disclosure can have various advantageous effects.

According to some embodiments of the present disclosure, a wireless device could transmit UL MO EDT data during MT EDT procedure.

For example, a wireless device may save power by proceeding MO EDT and MT EDT procedures in one random access channel (RACH) procedure.

For example, a wireless device may save radio resource by combining MO EDT with MT EDT procedure.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of a method for combining the MO EDT procedure with MT EDT procedure in a wireless communication system, according to some embodiments of the present disclosure.

FIG. 11 shows an example of a method for combining the MO EDT procedure with MT EDT procedure in a wireless communication system, according to some embodiments of the present disclosure.

FIG. 12 shows an example of a method for combining the MO EDT procedure with MT EDT procedure in a wireless communication system, according to some embodiments of the present disclosure.

FIG. 13 shows an example of a method for the MO EDT procedure to which implementations of the present disclosure is applied.

FIG. 14 shows an example of a method for the MO EDT procedure to which implementations of the present disclosure is applied.

FIG. 15 shows an example of a method for combining the MO EDT procedure with MT EDT procedure in a wireless communication system, according to some embodiments of the present disclosure.

FIG. 16 shows an example of a method for the MO EDT procedure to which implementations of the present disclosure is applied.

FIG. 17 shows an example of a method for the MO EDT procedure to which implementations of the present disclosure is applied.

### DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UNITS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regard to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDDCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

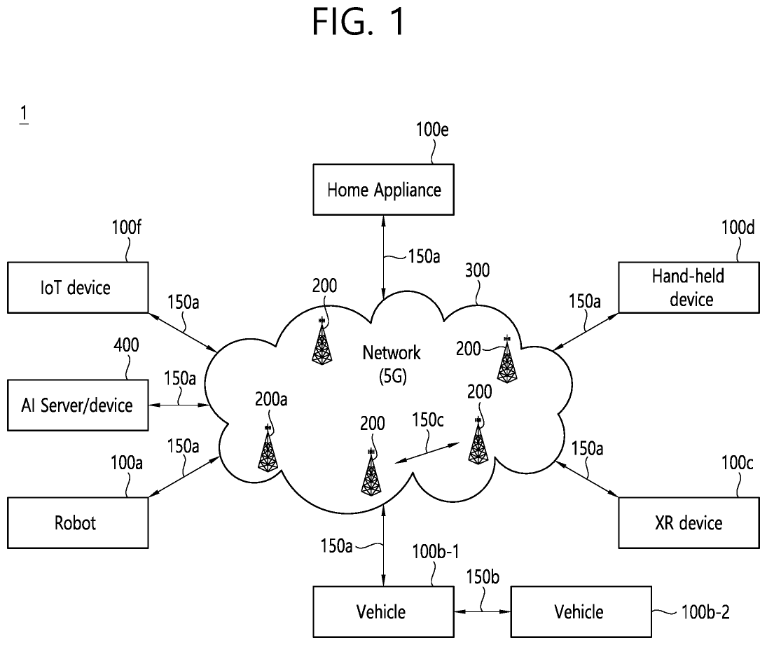

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructable wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

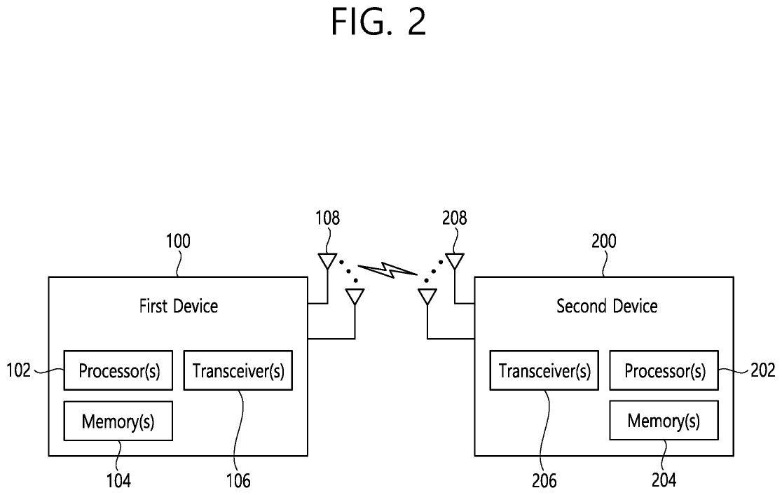

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

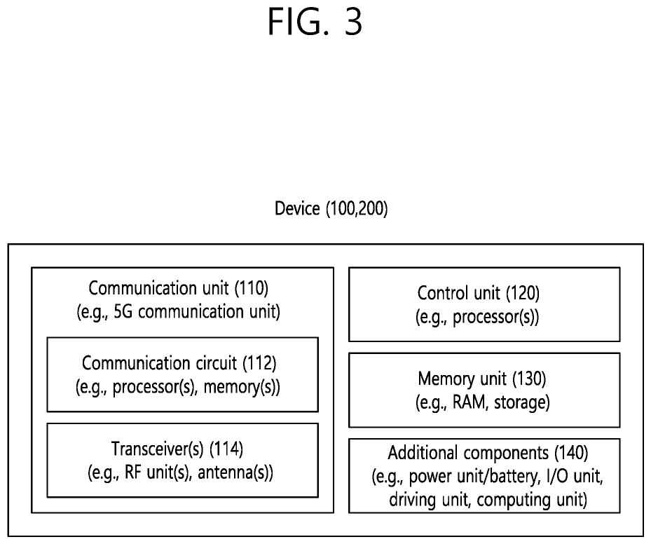

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

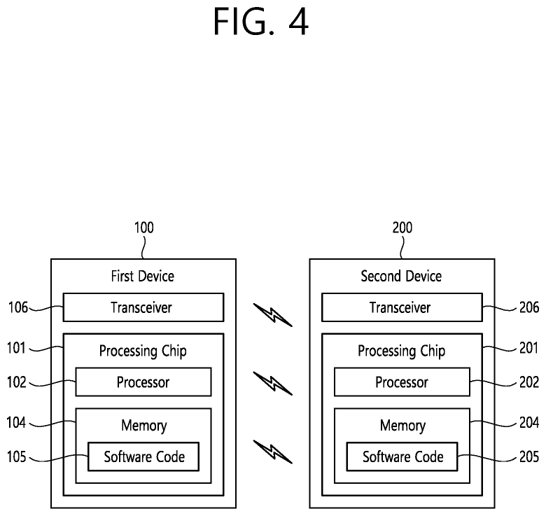

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

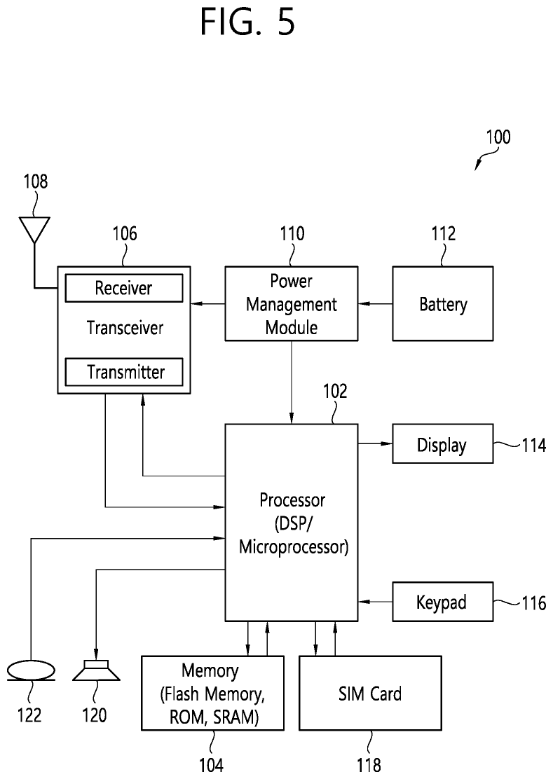

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

Hereinafter, an apparatus for combining MO EDT procedure with MT EDT procedure in a wireless communication system, according to some embodiments of the present disclosure, will be described.

Referring to FIG. 5, a wireless device 100 may include a processor 102, a memory 104, and a transceiver 106.

According to some embodiments of the present disclosure, the processor 102 may be configured to be coupled operably with the memory 104 and the transceiver 106. The processor 102 may be configured to control the transceiver 106 to receive, from a network, a paging including an indication informing that a mobile terminated early data transmission (MT EDT) procedure is initiated. The processor 102 may be configured to initiate the MT EDT procedure. The processor 102 may be configured to control the transceiver 106 to transmit, to the network, a specific random access preamble in the MT EDT procedure, wherein the specific random access preamble informs that an UL data originated by the wireless device is available.

Hereinafter, a processor for a wireless device for combining MO EDT procedure with MT EDT procedure in a wireless communication system, according to some embodiments of the present disclosure, will be described.

The processor may be configured to control the wireless device to receive, from a network, a paging including an indication informing that a mobile terminated early data transmission (MT EDT) procedure is initiated. The processor may be configured to control the wireless device to initiate the MT EDT procedure. The processor may be configured to control the wireless device to transmit, to the network, a specific random access preamble in the MT EDT procedure, wherein the specific random access preamble informs that an UL data originated by the wireless device is available.

Hereinafter, a non-transitory computer-readable medium has stored thereon a plurality of instructions for combining MO EDT procedure with MT EDT procedure in a wireless communication system, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored a plurality of instructions may be executed by a processor of a wireless device.

The stored a plurality of instructions may cause the wireless device to receive, from a network, a paging including an indication informing that a mobile terminated early data transmission (MT EDT) procedure is initiated. The stored a plurality of instructions may cause the wireless device to initiate the MT EDT procedure. The stored a plurality of instructions may cause the wireless device to transmit, to the network, a specific random access preamble in the MT EDT procedure, wherein the specific random access preamble informs that an UL data originated by the wireless device is available.

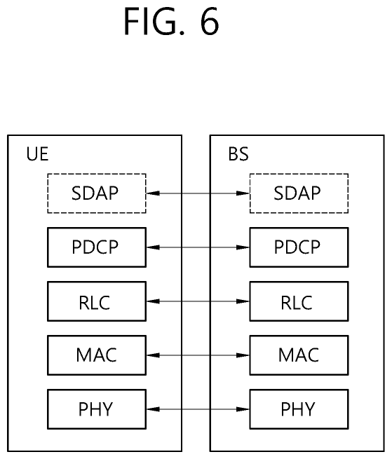

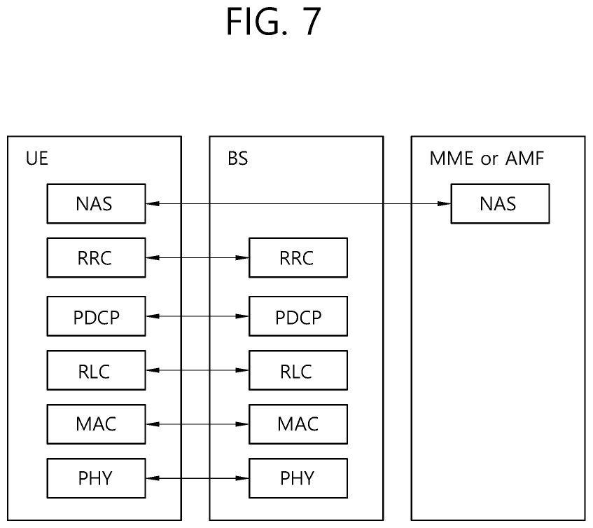

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection.

Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

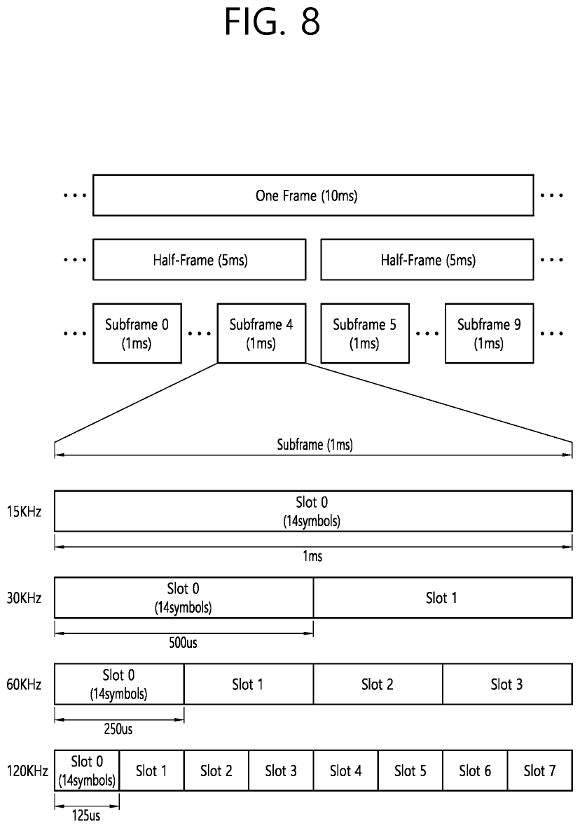

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2^{u}*15 kHz.

Table 1 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 kHz.

TABLE 1

| u | N^{slot}_{symb} | N^{frame,u}ₛₗₒₜ | Ns^{ubframe,u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 2

| u | N^{slot}_{symb} | N^{frame,u}ₛₗₒₜ | N^{subframe,u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain. In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding frequency | |
|---|---|---|
| designation | range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 4

| Frequency Range | Corresponding frequency | |
|---|---|---|
| designation | range | Subcarrier Spacing |
| FR1 | 410 MHz-7125 MHz | 15, 30, 60 kHz |
| FR2 | 24250 MHz-52600 MHz | 60, 120, 240 kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times. In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC CONNECTED not configured with CA/DC, there is only one serving cell comprised of the PCell. For a UE in RRC CONNECTED configured with CA/DC, the term “serving cells” is used to denote the set of cells comprised of the SpCell(s) and all SCells. In DC, two MAC entities are configured in a UE: one for the MCG and one for the SCG.

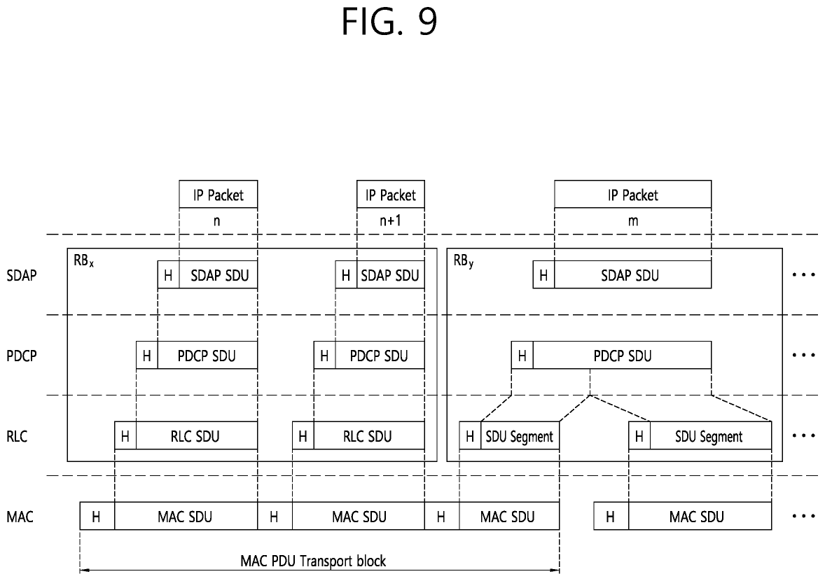

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels PUSCH and PRACH, respectively, and the downlink transport channels DL-SCH, BCH and PCH are mapped to PDSCH, PBCH and PDSCH, respectively. In the PHY layer, uplink control information (UCI) is mapped to PUCCH, and downlink control information (DCI) is mapped to PDCCH. A MAC PDU related to UL-SCH is transmitted by a UE via a PUSCH based on an UL grant, and a MAC PDU related to DL-SCH is transmitted by a BS via a PDSCH based on a DL assignment.

Meanwhile, a wireless device may receive downlink (DL) via RRC message during random access procedure. For example, a wireless device may receive the DL data by mobile terminated (MT) early data transmission (EDT) procedure.

In the MT EDT procedure, a wireless device could have mobile-originated (MO) data to be transmitted. However, there is no procedure for transmitting the MO data during the MT EDT procedure.

Therefore, studies for combining the MO EDT procedure with MT EDT procedure in a wireless communication system are required.

For example, in Message2 (Msg2) based MT EDT procedure, a UE may have UL data as an application level response of DL data. Also, the UE may have pending mobile-originated (MO) UL data.

In case that a UE have both UL data for a response of DL data and pending MO data that is applicable for MO EDT, in Control-plane (CP) EDT, the UE may have two Non-Access Stratum (NAS) Protocol Data Units (PDUs) to be transmitted in the step of Message3 (Msg3). There are two options to transmit the two NAS PDUs.

As a first option, the UE may transmit one NAS PDU in the existing Message3 (Msg3) and request UL grant for another NAS PDU. Then, the UE may transmit the remaining NAS PDU in Message5 (Msg5) after state transition to the Connected mode.

As a second option, the UE may transmit one NAS PDU (for example, UL data as a response of DL data) in the existing Msg3 and terminate MT EDT procedure. Then, the UE may initiate MO EDT procedure to transmit the remaining NAS PDU (for example, MO UL data applicable for MO EDT) without state transition.

In the both options above, the UE may consume power for UL data transmission after state transition in the first option and for proceeding two EDT procedures in the second option.

Therefore, studies for transmitting UL MO EDT data during MT EDT procedure are required.

Hereinafter, a method for combining the MO EDT procedure with MT EDT procedure in a wireless communication system, according to some embodiments of the present disclosure, will be described with reference to the following drawings.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings. Herein, a wireless device may be referred to as a user equipment (UE).

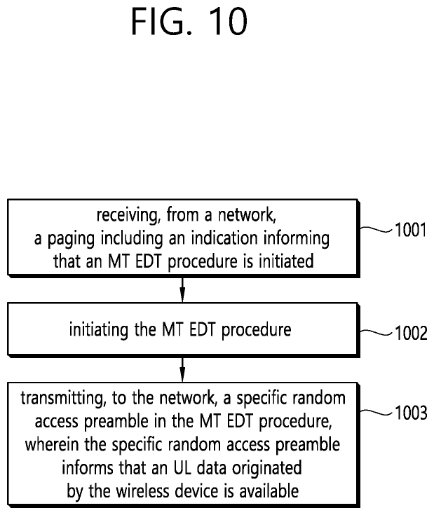

FIG. 10 shows an example of a method for combining the MO EDT procedure with MT EDT procedure in a wireless communication system, according to some embodiments of the present disclosure. In particular, FIG. 10 shows an example of a method performed by a wireless device.

In step 1001, a wireless device may receive, from a network, a paging including an indication informing that a mobile terminated early data transmission (MT EDT) procedure is initiated.

The paging may also include two sets of random access preambles. Each of the two sets of random access preambles may correspond to transmission mode of the wireless device. The transmission mode may include EDT in which the wireless device performs without state transition to RRC CONNECTED. For example, the transmission mode may include MT EDT. For another example, the transmission mode may include MT EDT followed by MO EDT. For example, the two sets of random access preambles may include one set of random access preambles used for MT EDT and the other set of random access preambles used for MT EDT followed by MO EDT, respectively. For example, the two sets of random access preambles may include one set of random access preambles used for EDT and the other set of random access preambles used for normal/legacy random access procedure.

In step 1002, a wireless device may initiate the MT EDT procedure.

In step 1003, a wireless device may transmit, to the network, a specific random access preamble in the MT EDT procedure, wherein the specific random access preamble informs that an UL data originated by the wireless device is available.

For example, a wireless device may select the specific random access preamble among multiple random access preambles from the two sets of random access preambles received from the network, which are included in the paging.

For example, the specific random access preamble may be configured for a mobile originated early data transmission (MO EDT). In other words, a wireless device may select a random access preamble configured for the MO EDT among multiples random access preambles from the two sets of random access preambles.

According to some embodiments of the present disclosure, a wireless device may receive, from the network, a first message including UL grant for the UL data in response to the specific random access preamble in the MT EDT procedure. For example, the first message may be a Random Access Response message in the MT EDT procedure. In other words, the first message may be a message2 (Msg2) in the MT EDT procedure.

According to some embodiments of the present disclosure, a wireless device may transmit, a second message including the UL data in the MT EDT procedure. For example, the second message may be an RRCEarlyDataRequest message in the MT EDT procedure. In other words, the second message may be a message3 (Msg3) in the MT EDT procedure.

For example, the second message may be transmitted via Common Control Channel (CCCH). The second message may include at least one of Non-Access Stratum (NAS) Protocol Data Units (PDUs) including the DL data (for example, CP-EDT).

For another example, the UL data may be transmitted via Dedicated traffic channel (DTCH) multiplexed with the second message (for example, UP-EDT).

For example, the second message may include resume cause mt-EDT.

According to some embodiments of the present disclosure, a wireless device may receive, from the network, a third message including a DL data in the MT EDT procedure.

For example, the third message may be a Random Access Response message in the MT EDT procedure. In other words, the second message may be a message2 (Msg2) in the MT EDT procedure.

For example, the third message may be received before transmitting the UL data to the network. In other words, the wireless device may receive the third message including the DL data before transmitting the second message including the UL data.

For another example, the third message may be an RRCEarlyDataComplete message in the MT EDT procedure. In other words, the second message may be a message4 (Msg4) in the MT EDT procedure.

For example, the wireless device may receive the third message after transmitting the UL data to the network. In other words, the wireless device may receive the third message including the DL data after transmitting the second message including the UL data.

For example, the third message may be transmitted via the CCCH to and includes at least one of NAS PDUs including the DL data (for example, CP-EDT).

For example, the DL data may be transmitted via DTCH multiplexed with the third message.

For example, the DL data may be concatenated in the third message.

According to some embodiments of the present disclosure, a wireless device may be in communication with at least one of a user equipment, a network, or an autonomous vehicle other than the wireless device.

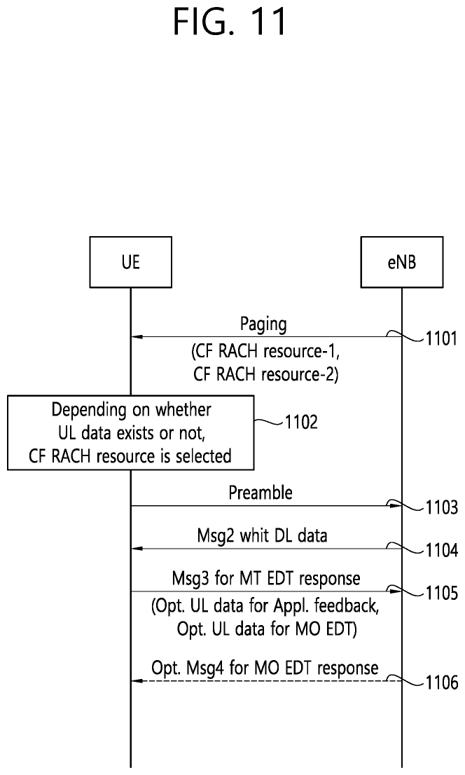

FIG. 11 shows an example of a method for combining the MO EDT procedure with MT EDT procedure in a wireless communication system, according to some embodiments of the present disclosure.

In this example, a UE may receive a message including two sets of RACH preamble and transmission mode from the network. If UL data is available, the UE may transmit the second preamble to use the second transmission mode (for example, MT EDT followed MO EDT). Otherwise, if UL data is not available, the UE may transmit the first preamble using the first transmission mode (for example, MT EDT only).

Referring to FIG. 11, UE may receive additional contention-free (CF) preamble in Paging to transmit UL data applicable for MO EDT in Msg3 during MT EDT procedure.

In step 1101, a UE may receive a paging indicating DL data and two RACH preambles for a transmission mode.

UE may receive a paging indicating MT EDT. For example, the indication may be explicit MT EDT indication. For another example, the indication may be a dedicated PRACH resource. For another example, the indication may be RNTI used during MT EDT procedure.

UE may receive two RACH preambles for a transmission mode. For example, a RACH preamble may include a contention-free (CF) RACH resource to indicate MT EDT procedure. For another example, a RACH preamble may include a CF RACH resource for Preamble transmission to request UL grant of UL data applicable for MO EDT during MT EDT. For another example, a RACH preamble may include a contention-based (CB) RACH resource to change to Msg4 based MT EDT procedure.

The transmission mode may be EDT in which the UE performs without state transition to RRC CONNECTED. For example, the transmission mode may include MT EDT. For another example, the transmission mode may include MT EDT followed by MO EDT.

In step 1102, UE may select a RACH preamble based on whether UL data exists or not.

For example, if UL data is not available, UE may select the first preamble using the first transmission mode.

For another example, if UL data is available, UE may select the second preamble using the second transmission mode (for example, MT EDT followed by MO EDT).

In step 1103, UE may transmit a selected RACH preamble.

If UL data is not available, UE may transmit the first preamble using the first transmission mode.

For example, UE may trigger RACH based on the first preamble to receive the DL data. For example, the first transmission mode may be the MT EDT only mode. For example, the RACH resource may be a dedicated resource to perform Msg2 based MT EDT.

If UL data is available, UE may transmit the second preamble using the second transmission mode (for example, MT EDT followed by MO EDT).

UE may trigger RACH based on the second preamble to transmit the UL data after receiving the DL data. For example, the second transmission mode may be the MT EDT followed by MO EDT mode.

For example, the RACH resource may be a dedicated resource to receive UL grant for Msg3 transmission of UL data applicable for MO EDT. For another example, the RACH resource may be a CB RACH resource to send UL data applicable for MO EDT in Msg3 and to receive MT EDT data in Msg4.

In step 1104, UE may receive Msg2.

According to some embodiments of the present disclosure, the Msg2 may include DL data.

For example, the Msg2 may be CB RA Response. In this case, the UE may perform Msg4 based MT EDT procedure after this step.

For example, the Msg2 RRC message may be integrity protected.

For example, the Msg2 may include NAS PDU including DL data (for example, control plane (CP) EDT).

For example, the Msg2 may consist of RRC message and DL data (for example, user plane (UP) EDT).

For example, the Msg2 may include UL grant for UL data transmission in Msg3 to combine MO EDT procedure during MT EDT.

According to some embodiments of the present disclosure, the Msg2 RRC format may be described as the table 5 below.

TABLE 5

| | |
|---|---|
| RRCEarlyDataTransfer-r16 ::= | SEQUENCE { |
| criticalExtensions | CHOICE { |
| rrcEarlyDataRequest-r15 | RRCEarlyDataTransfer-r16-IEs, |
| criticalExtensionsFuture | SEQUENCE { } |
| } | |
| } | |
| RRCEarlyDataTransfer-r16-IEs ::= | SEQUENCE { |
| s-TMSI-r16 | S-TMSI, |
| establishmentCause-r15 | ENUMERATED { mo-Data-r15, delayTolerantAccess- |
| r15}, | |
| dedicatedInfoNAS-r15 | DedicatedInfoNAS, OPTIONAL, // for CP solution |
| shortResumeMAC-I-r16 | BIT STRING (SIZE (16)), OPTIONAL, // for UP solution |
| nonCriticalExtension | SEQUENCE { } OPTIONAL |
| } | |

According to some embodiments of the present disclosure, Msg2 does not include the DL data. In this case, UE may receive the DL data via Msg4. That is, UE may receive MT data from the network, after transmit MO data to the network. In step 1105, UE may transmit Msg3.

For example, Msg3 may include UL data and/or response of DL data.

For example, Msg3 may include one or two NAS PDUs (for example, CP EDT).

For example, Msg3 may include MAC PDU multiplexing one RRC message in CCCH and/or one or two UL data in DTCH (For example, UP EDT).

For example, Msg3 may be integrity protected.

For example, if UL grant is not big enough to transmit pending UL data, the UE may proceed MT EDT procedure in advance.

According to some embodiments of the present disclosure, the Msg3 RRC format may be described as the table 6 below.

TABLE 6

| | |
|---|---|
| RRCEarlyDataResponse-r16 ::= | SEQUENCE { |
| criticalExtensions | CHOICE { |
| rrcEarlyDataResponse-r16 | RRCEarlyDataResponse-r16-IEs, |
| criticalExtensionsFuture | SEQUENCE { } |
| } | |
| } | |
| RRCEarlyDataResponse-r16-IEs ::= | SEQUENCE { |
| s-TMSI-r16 | S-TMSI, |
| establishmentCause-r16 | ENUMERATED { mo-Data-r16, delayTolerantAccess- |
| r16, mt-Edt-r16}, | |
| dedicatedInfoNAS1-r16 | DedicatedInfoNAS, OPTIONAL, // for CP solution |
| dedicatedInfoNAS2-r16 | DedicatedInfoNAS, OPTIONAL, // for CP solution |
| shortResumeMAC-I-r16 | BIT STRING (SIZE (16)), OPTIONAL, // for UP solution |
| nonCriticalExtension | SEQUENCE { } OPTIONAL |
| } | |
| MoEDT-r16-IEs ::= | SEQUENCE { |
| ... | |
| } | |

In step 1106, UE may receive Msg4 for MO EDT response. For example, UE may not receive DL data in step 1104. In this case, UE may receive MT data with Msg4.

For example, the Msg4 may include DL data.

For example, the Msg2, in step 1104, may be CB RA Response and the UE may perform Msg4 based MT EDT in step 1106.

For example, the Msg4 RRC message may be integrity protected.

For example, the Msg4 may include NAS PDU including DL data (for example, control plane (CP) EDT).

For example, the Msg4 may consist of RRC message and DL data (for example, user plane (UP) EDT).

Hereinafter, some embodiments for combining the MO EDT procedure with MT EDT procedure in a wireless communication system according to the present disclosure will be described.

According to some embodiments of the present disclosure, MT-EDT may be intended for a single downlink data transmission during the random access procedure.

For example, MT-EDT may be initiated by the MME, if the UE and the network support MT-EDT and there is a single DL data transmission for the UE.

For example, support for MT-EDT for the Control Plane CIoT EPS Optimisation may be reported by UE at NAS level.

For example, DL data size may be included in the S1-AP Paging message for the UE.

For example, MT-EDT indication may be included in the Paging message for the UE over the Uu interface.

For example, for User Plane CIoT EPS Optimisation, the UE has been provided with a NextHopChainingCount in the RRCConnectionRelease message with suspend indication.

For example, in response to the Paging message including MT-EDT indication, the UE may trigger the MO-EDT procedure for Control Plane CIoT EPS Optimisation or for User Plane CIoT EPS Optimisation if the upper layers request the establishment or resumption of the RRC Connection for Mobile Terminated Call.

For example, UE may not transit to RRC CONNECTED.

For example, MT-EDT is only applicable to BL UEs, UEs in enhanced coverage and NB-IoT UEs.

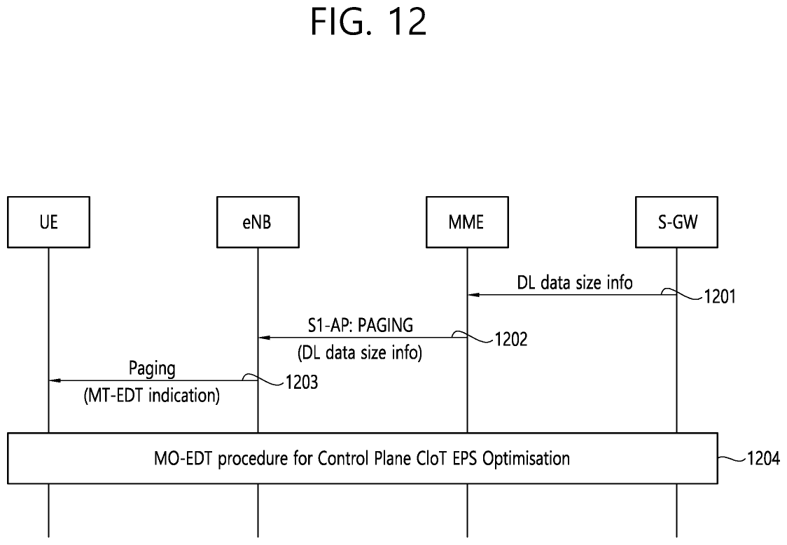

FIG. 12 shows an example of a method for combining the MO EDT procedure with MT EDT procedure in a wireless communication system, according to some embodiments of the present disclosure. In particular, FIG. 12 shows MT-EDT procedure for Control Plane CIoT EPS Optimisation.

In step 1201, upon arrival of downlink (DL) data, the SGW may send the DL data size information to the MME for MT-EDT consideration by the MME.

In step 1202, the MME may include the DL data size information in the S1-AP PAGING message to assist eNodeB in triggering MT-EDT.

In step 1203, if the data can fit in one single downlink transmission according to the UE category included in the UE Radio Capability for Paging provided in the S1-AP Paging message, the eNB includes mt-EDT indication in the Paging message for the UE.

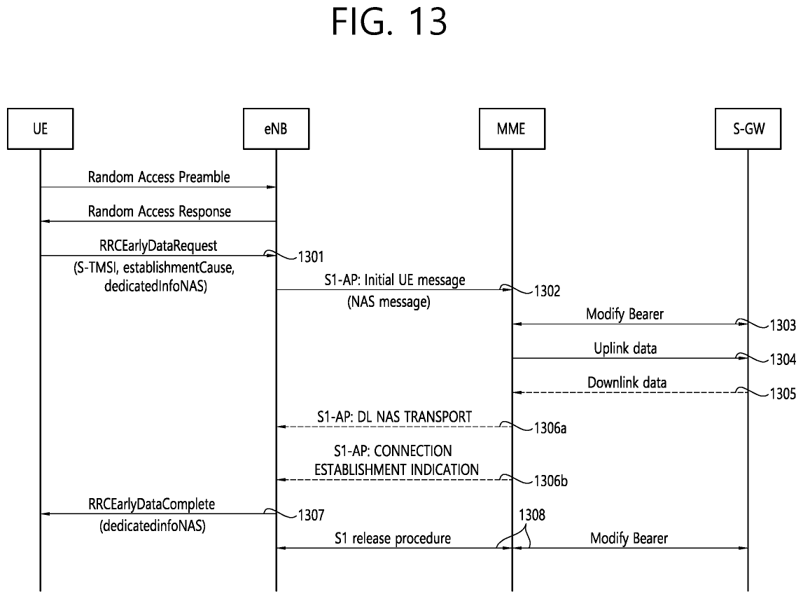

In step 1204, the may UE initiate the MO-EDT procedure for the Control Plane CIoT EPS Optimisation, which will be described below in FIG. 13.

For example, UE may select and transmit, to the eNB, a RACH preamble configured for the MO-EDT. For example, UE may select and transmit, to the eNB, a RACH preamble indicating that UL data is available.

UE may receive, from the eNB, Msg2 including UL grant for the UL data transmission. UE may transmit, to the eNB, Msg3 including the UL data (for example, Msg3 may include one or two NAS PDUs). UE may receive, from the eNB, Msg4 including the DL data (for example, MT data).

In FIG. 12, eNB, MME, and S-GW are described as network nodes and/or core-network nodes in a wireless communication system. However, present disclosure is not limited thereto.

According to some embodiments of the present disclosure, ng-eNB, AMF, and SMF/UPF could be a network nodes and/or core-network nodes in the wireless communication system.

In this case, upon arrival of downlink (DL) data, the SMF and/or UPF may send the DL data size information to the AMF for MT-EDT consideration by the AMF.

The AMF may include the DL data size information in the PAGING message to assist ng-eNB in triggering MT-EDT.

If the data can fit in one single downlink transmission according to the UE category included in the UE Radio Capability for Paging provided in the Paging message, the ng-eNB includes mt-EDT indication in the Paging message for the UE.

The may UE initiate the MO-EDT procedure for the Control Plane CIoT 5GS Optimisation, which will be described below in FIG. 13.

For example, UE may select and transmit, to the ng-eNB, a RACH preamble configured for the MO-EDT. For example, UE may select and transmit, to the ng-eNB, a RACH preamble indicating that UL data is available.

UE may receive, from the ng-eNB, Msg2 including UL grant for the UL data transmission. UE may transmit, to the ng-eNB, Msg3 including the UL data (for example, Msg3 may include one or two NAS PDUs). UE may receive, from the ng-eNB, Msg4 including the DL data (for example, MT data).

FIG. 13 shows an example of a method for the MO EDT procedure to which implementations of the present disclosure is applied. In particular, FIG. 13 shows MO-EDT for Control Plane CIoT EPS Optimisation.

For example, in the MO-EDT for Control Plane CIoT EPS Optimisation, uplink user data may be transmitted in a NAS message concatenated in UL RRCEarlyDataRequest message on CCCH.

For example, downlink user data are optionally transmitted in a NAS message concatenated in DL RRCEarlyDataComplete message on CCCH.

For example, there is no transition to RRC CONNECTED.

In step 1300, upon connection establishment request for Mobile Originated data from the upper layers, the UE may initiate the MO-EDT procedure and selects a random access preamble configured for EDT.

For example, UE may initiate the MO-EDT procedure upon receiving a paging message including mt-EDT indication from a network.

For example, UE may select a random access preamble configured for EDT among random access preambles received from the network. For example, UE may transmit the selected random access preamble configured for MO-EDT.

For example, UE may receive two random access preambles via the paging message.

Referring to FIG. 13, in step 1301, UE may send RRCEarlyDataRequest message concatenating the user data on CCCH. For EPS if enabled in the cell, the UE may indicate AS Release Assistance Information. For example, the UE may send RRCEarlyDataRequest message with the establishment cause mt-Access and without user data.

In step 1302, for EPS, the eNB may initiate the S1-AP Initial UE message procedure to forward the NAS message and establish the S1 connection.

In step 1303, for EPS, the MME may request the S-GW to re-activate the EPS bearers for the UE.

In step 1304, for EPS, the MME may send the uplink data to the S-GW.

In step 1305, for EPS, if downlink data are available, the S-GW may send the downlink data to the MME.

In step 1306, if downlink data are received from the S-GW, the MME may forward the data to the eNB via DL NAS Transport procedure and may also indicate whether further data are expected.

Otherwise, the MME may trigger Connection Establishment Indication procedure and also indicate whether further data are expected.

In step 1307, if no further data are expected, the eNB could send the RRCEarlyDataComplete message on CCCH to keep the UE in RRC IDLE. If downlink data were received in step 1306, they are concatenated in RRCEarlyDataComplete message.

For example, in case of fall back to the RRC Connection establishment procedure, the downlink data may optionally be included in RRCConnectionSetup message.

In step 1308, for EPS, the S1 connection is released and the EPS bearers are deactivated.

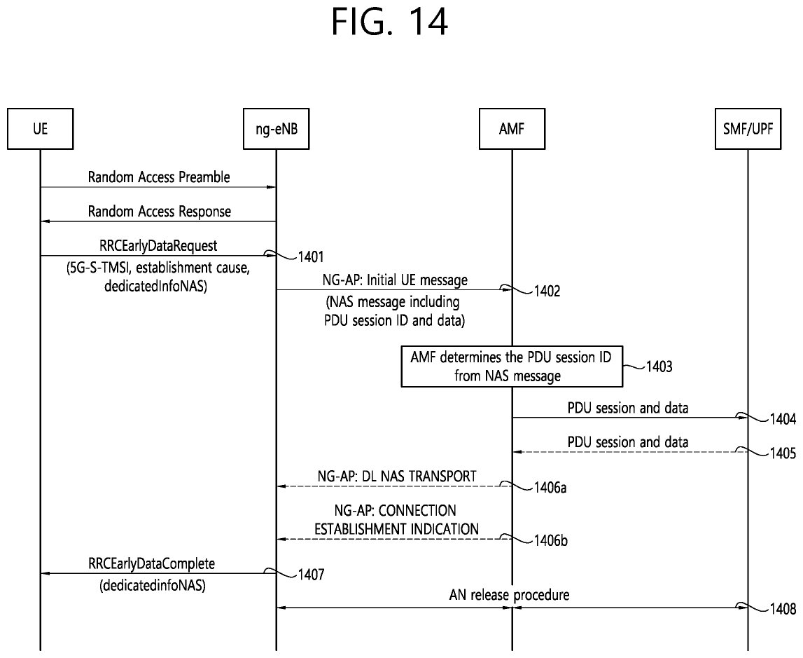

FIG. 14 shows an example of a method for the MO EDT procedure to which implementations of the present disclosure is applied. In particular, FIG. 14 shows MO-EDT for Control Plane CIoT 5GS Optimisation.

For example, in the MO-EDT for Control Plane CIoT 5GS Optimisation, uplink user data may be transmitted in a NAS message concatenated in UL RRCEarlyDataRequest message on CCCH.

For example, downlink user data are optionally transmitted in a NAS message concatenated in DL RRCEarlyDataComplete message on CCCH.

For example, there is no transition to RRC CONNECTED.

In step 1400, upon connection establishment request for Mobile Originated data from the upper layers, the UE may initiate the MO-EDT procedure and selects a random access preamble configured for EDT.

For example, UE may initiate the MO-EDT procedure upon receiving a paging message including mt-EDT indication from a network.

For example, UE may select a random access preamble configured for EDT among random access preambles received from the network. For example, UE may transmit the selected random access preamble configured for MO-EDT.

For example, UE may receive two random access preambles via the paging message.

Referring to FIG. 14, in step 1401, UE may send RRCEarlyDataRequest message concatenating the user data on CCCH. For 5GS, the UE may indicate AS Release Assistance Information. For example, the UE may send RRCEarlyDataRequest message with the establishment cause mt-Access and without user data.

In step 1402, for 5GS, the ng-eNB may initiate the NG-AP Initial UE message procedure to forward the NAS message. The ng-eNB may indicate in this procedure that this connection is triggered for EDT.

In step 1403, for 5GS, the AMF may determine the PDU session contained in the NAS message.

In step 1404, for 5GS, the AMF may send the PDU Session ID and the uplink data to the SMF and the SMF forwards the uplink data to the UPF.

In step 1405, for 5GS, if downlink data are available, the UPF may forward the downlink data to SMF and the SFM may forward the downlink data to AMF.

In step 1406, if downlink data are received from the SMF, AMF may forward the data to the ng-eNB via DL NAS Transport procedure and may also indicate whether further data are expected.

Otherwise, the AMF may trigger Connection Establishment Indication procedure and also indicate whether further data are expected.

In step 1407, if no further data are expected, the ng-eNB could send the RRCEarlyDataComplete message on CCCH to keep the UE in RRC IDLE. If downlink data were received in step 1406, they are concatenated in RRCEarlyDataComplete message.

For example, in case of fall back to the RRC Connection establishment procedure, the downlink data may optionally be included in RRCConnectionSetup message.

In step 1408, for 5GS, the AN release procedure is started.

In FIGS. 13 and 14, if the MME/AMF or the (ng-)eNB decides to move the UE in RRC CONNECTED mode, RRCConnectionSetup message is sent in step 1307 or step 1407 to fall back to the legacy RRC Connection establishment procedure. In other words, the (ng-)eNB will discard the zero-length NAS PDU received in RRCConnectionSetupComplete message.

If neither RRCEarlyDataComplete nor, in case of fallback, RRCConnectionSetup is received in response to RRCEarlyDataRequest, the UE may consider the UL data transmission not successful.

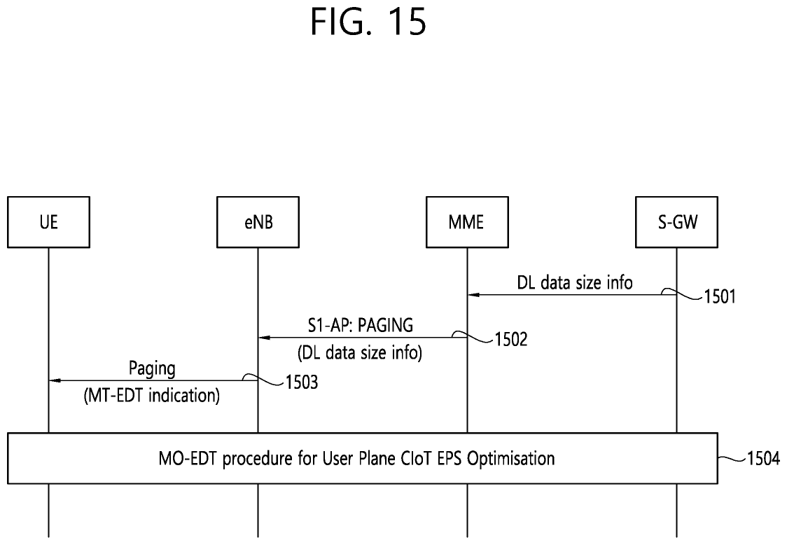

FIG. 15 shows an example of a method for combining the MO EDT procedure with MT EDT procedure in a wireless communication system, according to some embodiments of the present disclosure. In particular, FIG. 12 shows MT-EDT procedure for User Plane CIoT EPS Optimisation.

According to some embodiments of the present disclosure, MT-EDT may be intended for a single downlink data transmission during the random access procedure.

For example, MT-EDT may be initiated by the MME, if the UE and the network support MT-EDT and there is a single DL data transmission for the UE.

In step 1501, upon arrival of downlink data, the SGW may send the DL data size to the MME for MT-EDT consideration by the MME.

In step 1502, the MME includes the DL data size in the S1-AP PAGING message to assist eNodeB in triggering MT-EDT.

In step 1503, if the data can fit in one single downlink transmission according to the UE category included in the UE Radio Capability for Paging provided in the S1-AP Paging message, the eNB may include mt-EDT indication in the Paging message for the UE.

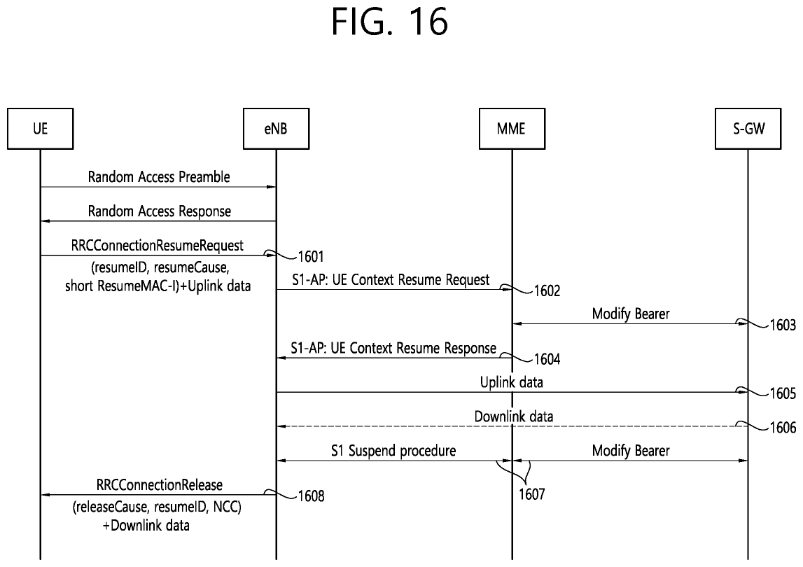

In step 1504, the UE may initiate the MO-EDT procedure for the User Plane CIoT EPS Optimisation, which will be described below in FIG. 16.

For example, UE may select and transmit, to the eNB, a RACH preamble indicating that UL data is available.

UE may receive, from the eNB, Msg2 including UL grant for the UL data transmission. UE may transmit, to the eNB, Msg3 including the UL data. UE may receive, from the eNB, Msg4 including the DL data.

In FIG. 15, eNB, MME, and S-GW are described as network nodes and/or core-network nodes in a wireless communication system. However, present disclosure is not limited thereto.

According to some embodiments of the present disclosure, ng-eNB, AMF, and SMF/UPF could be a network nodes and/or core-network nodes in the wireless communication system.

In this case, upon arrival of downlink (DL) data, the SMF and/or UPF may send the DL data size information to the AMF for MT-EDT consideration by the AMF.

The AMF may include the DL data size information in the PAGING message to assist ng-eNB in triggering MT-EDT.

If the data can fit in one single downlink transmission according to the UE category included in the UE Radio Capability for Paging provided in the Paging message, the ng-eNB may include mt-EDT indication in the Paging message for the UE.

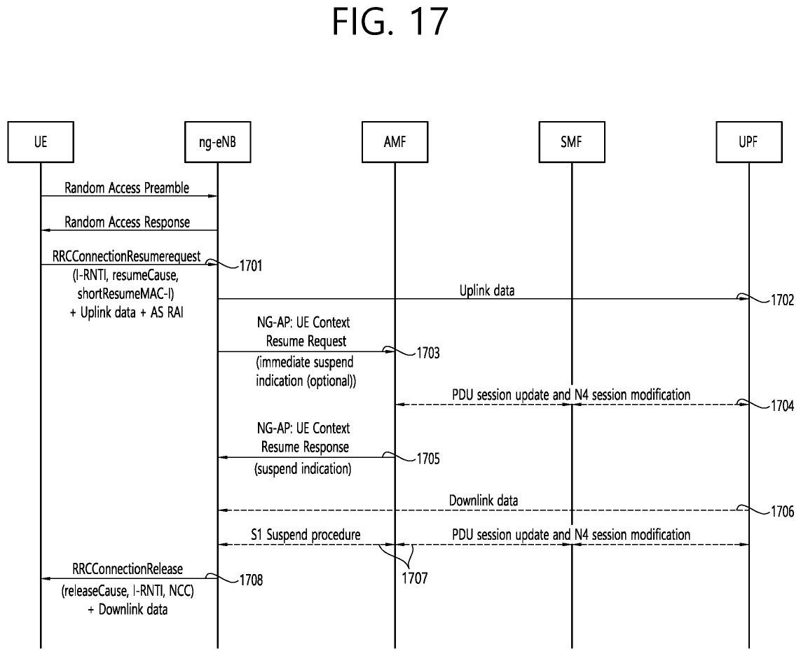

The may UE initiate the MO-EDT procedure for the User Plane CIoT 5GS Optimisation, which will be described below in FIG. 17.

For example, UE may select and transmit, to the ng-eNB, a RACH preamble configured for the MO-EDT. For example, UE may select and transmit, to the ng-eNB, a RACH preamble indicating that UL data is available.

UE may receive, from the ng-eNB, Msg2 including UL grant for the UL data transmission. UE may transmit, to the ng-eNB, Msg3 including the UL data. UE may receive, from the ng-eNB, Msg4 including the DL data.

FIG. 16 shows an example of a method for the MO EDT procedure to which implementations of the present disclosure is applied. In particular, FIG. 16 shows MO-EDT for User Plane CIoT EPS Optimisation.

For example, in the MO-EDT for User Plane CIoT EPS optimisation, uplink user data may be transmitted on DTCH multiplexed with UL RRCConnectionResumeRequest message on CCCH.

For example, downlink user data may be optionally transmitted on DTCH multiplexed with DL RRCConnectionRelease message on DCCH.

For example, there is no transition to RRC CONNECTED.

Referring to FIG. 16, in step 1600, upon connection resumption request for Mobile Originated data from the upper layers, the UE may initiate the MO-EDT procedure and selects a random access preamble configured for EDT.

For example, if UL data is not available, the UE selects a random access preamble not configured for EDT.

In step 1601, the UE may send an RRCConnectionResumeRequest to the eNB, including its Resume ID, the establishment cause, and an authentication token. The UE may resume all SRBs and DRBs, derive new security keys using the NextHopChainingCount provided in the RRCConnectionRelease message of the previous RRC connection and re-establish the AS security. The user data may be ciphered and transmitted on DTCH multiplexed with the RRCConnectionResumeRequest message on CCCH. If enabled in the cell, the UE may indicate AS Release Assistance Information.

For another example, the UE may send RRCConnectionResumeRequest message with the resume cause mt-EDT and without user data.

In step 1602, the eNB may initiate the S1-AP Context Resume procedure to resume the S1 connection and re-activate the S1-U bearers.

In step 1603, the MME may request the S-GW to re-activate the S1-U bearers for the UE.

In step 1604, the MME may confirm the UE context resumption to the eNB.

For another example, the MME may include the Pending Data Indication in the S1AP UE Context Resume Response message to notify the eNB of further data traffic in excess of that initially signalled in step 1602. The eNB may use this indication to decide whether to release the UE.

In step 1605, the uplink data may be delivered to the S-GW.

In step 1606, if downlink data are available, the S-GW may send the downlink data to the eNB.

In step 1607, if no further data are expected, the eNB can initiate the suspension of the S1 connection and the deactivation of the S1-U bearers.

In step 1608, the eNB may send the RRCConnectionRelease message to keep the UE in RRC IDLE. The message may include the release Cause set to rrc-Suspend, the resumeID, the NextHopChainingCount and drb-ContinueROHC which are stored by the UE. If downlink data were received in step 1606, they are sent ciphered on DTCH multiplexed with the RRCConnectionRelease message on DCCH.

FIG. 17 shows an example of a method for the MO EDT procedure to which implementations of the present disclosure is applied. In particular, FIG. 17 shows MO-EDT for User Plane CIoT 5GS Optimisation.

In step 1700, upon connection resumption request for Mobile Originated data from the upper layers, the UE initiates the MO-EDT procedure and selects a random access preamble configured for EDT.

For example, if UL data is not available, the UE selects a random access preamble not configured for EDT.

In step 1701, the UE mat send an RRCConnectionResumeRequest to the ng-eNB, including its I-RNTI, the resume cause, and an authentication token. The UE may resume all SRBs and DRBs, derive new security keys using the NextHopChainingCount provided in the RRCConnectionRelease message of the previous connection and re-establish the AS security. The user data may be ciphered and transmitted on DTCH multiplexed with the RRCConnectionResumeRequest message on CCCH. The UE may indicate AS Release Assistance Information.

In step 1702, the uplink data may be delivered to the UPF.

In step 1703, the ng-eNB may send a NG-AP Context Resume Request message to the AMF to resume the connection. If the UE included AS Release Assistance information indicating No further UL/DL higher layer PDU in step 1701, ng-eNB may request for immediate transition to RRC IDLE with Suspend.

In step 1704, if the AMF does not receive a request for immediate transition to RRC IDLE with Suspend in step 1703 or the AMF is aware of downlink data or signalling pending, the AMF may request the SMF to resume the PDU session.

In step 1705, the AMF may send a NG-AP Context Resume Response to the ng-eNB. If the AMF receives a request for immediate transition to RRC IDLE with Suspend in step 1703 and there is no downlink data or signalling pending, the AMF may include a Suspend indication, and keeps the UE in CM-IDLE with Suspend.

1706, if the AMF includes Suspend indication in step 1705, the ng-eNB proceeds to step 1708. If the AMF does not include Suspend indication and the UE included AS Release Assistance information indicating Only a single Downlink Data transmission subsequent to the Uplink transmission in step 1701, the ng-eNB may wait for the DL data to arrive, and proceeds to step 1707.

In step 1707, the ng-eNB may initiate the NG-AP UE Context Suspend procedure to inform the AMF that the RRC connection is being suspended. The AMF may request the SMF to suspend the PDU session and the SMF may request the UPF to release the tunnel information for the UE.

In step 1708, the eNB may sends the RRCConnectionRelease message to keep the UE in RRC IDLE. The message may include the release Cause set to rrc-Suspend, the I-RNTI, the NextHopChainingCount and drb-ContinueROHC which are stored by the UE. If downlink data were received in step 1706, they are sent ciphered on DTCH multiplexed with the RRCConnectionRelease message on DCCH.

In FIGS. 16 and 17, for example, if the MME/AMF or (ng-)eNB decides the UE to move in RRC CONNECTED mode, RRCConnectionResume message is sent in step 1607 or step 1707 to fall back to the RRC Connection resume procedure. In that case, the RRCConnectionResume message is integrity protected and ciphered with the keys derived in step 1601 or 1701 and the UE ignores the NextHopChainingCount included in the RRCConnectionResume message. Downlink data can be transmitted on DTCH multiplexed with the RRCConnectionResume message. In addition, an RRCConnectionSetup can also be sent in step 1607 or step 1707 to fall back to the RRC Connection establishment procedure.

For example, if neither RRCConnectionRelease nor, in case of fallback, RRCConnectionResume is received in response to RRCConnectionResumeRequest for MO-EDT, the UE considers the UL data transmission not successful.

Hereinafter, some embodiments for combining the MO EDT procedure with MT EDT procedure in a wireless communication system according to the present disclosure will be described. In particular, conditions for initiating the MO EDT procedure during the MT EDT procedure will be described.

According to some embodiments, a BL UE, UE in CE or NB-IoT UE can initiate EDT when all of the following conditions are fulfilled.

1> if the UE is connected to EPC:

2> for CP-EDT, the upper layers request establishment of an RRC connection, the UE supports CP-EDT, and SystemInformationBlockType2 (SystemInformationBlockType2-NB in NB-IoT) includes cp-EDT; or

2> for UP-EDT, the upper layers request resumption of an RRC connection, the UE supports UP-EDT, SystemInformationBlockType2 (SystemInformationBlockType2-NB in NB-IoT) includes up-EDT, and the UE has a stored value of the nextHopChainingCount provided in the RRCConnectionRelease message with suspend indication during the preceding suspend procedure;

1> else if the UE is connected to 5GC:

2> for CP-EDT, the upper layers request establishment of an RRC connection, the UE connected to 5GC supports CP-EDT, and SystemInformationBlockType2 (SystemInformationBlockType2-NB in NB-IoT) includes cp-EDT-5GC; or

2> for UP-EDT, the upper layers request resumption of an RRC connection, the UE connected to 5GC supports UP-EDT, SystemInformationBlockType2 (SystemInformationBlockType2-NB in NB-IoT) includes up-EDT-5GC, and the UE has a stored value of the nextHopChainingCount provided in the RRCConnectionRelease message with suspend indication during the preceding suspend procedure;

1> the establishment or resumption request is for mobile originating calls and the establishment cause is mo-Data or mo-ExceptionData or delayTolerantAccess; or

1> the establishment or resumption request is for mobile terminating calls in response to the Paging message including mt-EDT and the establishment cause is mt-Access;

1> the establishment or resumption request is suitable for EDT;

1> SystemInformationBlockType2 (SystemInformationBlockType2-NB in NB-IoT) includes edt-Parameters;

1> for mobile originating calls, the size of the resulting MAC PDU including the total UL data is expected to be smaller than or equal to the TBS signalled in edt-TBS;

1> EDT fallback indication has not been received from lower layers for this establishment or resumption procedure;

Upper layers request or resume an RRC connection. The interaction with NAS is up to UE implementation.

It is up to UE implementation how the UE determines whether the size of UL data is suitable for EDT.

According to some embodiments of the present disclosure, a UE may combine the MO EDT procedure and the MT EDT procedure in actions related to transmission of RRCConnectionResumeRequest message.

For example, if the UE is resuming the RRC connection from a suspended RRC connection, the UE shall set the contents of RRCConnectionResumeRequest message as follows.

1> if the UE is initiating UP-EDT for mobile terminating calls in accordance with conditions described above:

2> set the resumeCause to mt-EDT;

1> if the UE is resuming an RRC connection after early security reactivation:

2> if the UE is initiating UP-EDT for mobile originated calls in accordance with conditions described above:

3> configure the lower layers to use EDT;

For example, RRC layer of the UE may configure the MAC layer to use EDT when the UE initiate UP-EDT for mobile originated calls, which means that the UL data is available. Therefore, UE may transmit the UL data via the RRCConnectionResumeRequest message in a random access procedure.

According to some embodiments of the present disclosure, a UE may combine the MO EDT procedure and the MT EDT procedure in actions related to transmission of RRCEarlyDataRequest message.

The UE shall set the contents of RRCEarlyDataRequest message as follows.

The UE shall:

1> if the UE is initiating CP-EDT in accordance with conditions described above:

2> configure the lower layers to use EDT;

1> submit the RRCEarlyDataRequest message to the lower layers for transmission.

For example, RRC layer of the UE may configure the MAC layer to use EDT when the UE initiate CP-EDT.

In particular, the UE may initiate the CP-EDT based on that the UL data is available. Therefore, UE may transmit the UL data via the of RRCEarlyDataRequest message in a random access procedure.

The present disclosure can have various advantageous effects.

According to some embodiments of the present disclosure described with reference to FIGS. 10 to 17, a wireless device could transmit UL MO EDT data during MT EDT procedure.

For example, a wireless device may save power by proceeding MO EDT and MT EDT procedures in one random access channel (RACH) procedure.

For example, a wireless device may save radio resource by combining MO EDT with MT EDT procedure.

If a method for combining MO EDT with MT EDT, according to some embodiments of the present disclosure, is not supported, the UE would perform MO EDT procedure after completion of MT EDT. Otherwise, the UE would transmit UL data applicable for MO EDT after state transition on reception of Msg4.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a wireless device in a wireless communication system, the method comprising,
receiving, from a network, a paging including an indication informing that a mobile terminated early data transmission (MT EDT) procedure is initiated;
initiating the MT EDT procedure;
transmitting, to the network, a specific random access preamble in the MT EDT procedure, wherein the specific random access preamble informs that an UL data originated by the wireless device is available;
receiving, from the network, a first message including UL grant for the UL data in response to the specific random access preamble in the MT EDT procedure; and
transmitting, a second message including the UL data in the MT EDT procedure.

2. The method of claim 1, wherein the method further comprises,
receiving, from the network, two random access preambles; and
selecting the specific random access preamble among the two random access preambles.

3. The method of claim 2, wherein the two random access preambles are included in the paging.

4-5. (canceled)

6. The method of claim 1, wherein the second message is transmitted via Common Control Channel (CCCH) and includes at least one of Non-Access Stratum (NAS) Protocol Data Units (PDUs) including the UL data.

7. The method of claim 1, wherein the UL data is transmitted via Dedicated traffic channel (DTCH) multiplexed with the second message.

8. The method of claim 1, wherein the second message includes resume cause mt-EDT.

9. The method of claim 1, wherein the method further comprises,
receiving, from the network, a third message including a DL data in the MT EDT procedure.

10. The method of claim 9, wherein the third message is received after transmitting the UL data to the network.

11. The method of claim 9, wherein the third message is received before transmitting the UL data to the network.

12. The method of claim 9, wherein the third message is transmitted via the CCCH data and includes at least one of NAS PDUs including the DL data.

13. The method of claim 9, wherein the DL data is transmitted via DTCH multiplexed with the third message.

14. The method of claim 1, wherein the specific random access preamble is configured for a mobile originated early data transmission (MO EDT).

15. The method of claim 1, wherein the wireless device is in communication with at least one of a user equipment, a network, or an autonomous vehicle other than the wireless device.

16. A wireless device in a wireless communication system comprising:
a transceiver;
a memory; and
at least one processor operatively coupled to the transceiver and the memory, and configured to:
control the transceiver to receive, from a network, a paging including an indication informing that a mobile terminated early data transmission (MT EDT) procedure is initiated;
initiate the MT EDT procedure;
control the transceiver to transmit, to the network, a specific random access preamble in the MT EDT procedure, wherein the specific random access preamble informs that an UL data originated by the wireless device is available;
control the transceiver to receive, from the network, a first message including UL grant for the UL data in response to the specific random access preamble in the MT EDT procedure; and
control the transceiver to transmit, a second message including the UL data in the MT EDT procedure.

17. A non-transitory computer-readable medium having stored thereon a plurality of instructions, which, when executed by a processor of a wireless device, cause the wireless device to:
receive, from a network, a paging including an indication informing that a mobile terminated early data transmission (MT EDT) procedure is initiated;
initiate the MT EDT procedure;
transmit, to the network, a specific random access preamble in the MT EDT procedure, wherein the specific random access preamble informs that an UL data originated by the wireless device is available;
receive, from the network, a first message including UL grant for the UL data in response to the specific random access preamble in the MT EDT procedure; and
transmit, a second message including the UL data in the MT EDT procedure.
